(19) United States
(12) Patent Application Publication
(10) Pub. No.: US 2009/0288774 A1
(43) Pub. Date: Nov. 26, 2009

(54) SUBSTRATE BONDING APPARATUS

(75) Inventors: Yutaka Matsumoto, Tokyo (JP); Tetsuya Okamoto, Tokyo (JP)

Correspondence Address: LATIMER, MAYBERRY & MATTHEWS IP LAW, LLP, 13873 PARK CENTER ROAD, SUITE 106, HERNDON, VA, 20171, US

(73) Assignee: Origin Electric Company, Limited, Tokyo (JP)

(21) Appl. No.: 12/469,175

(22) Filed: May 20, 2009

(30) Foreign Application Priority Data
May 20, 2008 (JP) 2008-132418

(51) Int. Cl. B32B 43/00

(52) U.S. Cl. 156/379.8; 156/538

(57) ABSTRACT

To provide a substrate bonding apparatus for manufacturing a substrate with a retainer capable of meeting standard requirements while reducing damage on the information recording surface of the substrate. The apparatus comprises a loading pedestal 11 on which a plate-shaped substrate D is placed; a suctioning and holding member 21 (see FIG. 2) for suctioning and holding a plate-shaped retainer R smaller than the substrate D on a side opposite the loading pedestal 11 beyond the substrate D placed on the loading pedestal 11; a moving device 13m for bringing the loading pedestal 11 and the suctioning and holding member 21 close toward each other so that the substrate D placed on the loading pedestal 11 and the retainer R suctioned and held with the suctioning and holding member 21 connected through adhesive; and a pressing member 25 for pressing down the substrate D placed on the loading pedestal 11 so that the substrate D does not come off the loading pedestal 11. The pressing member facilitates the retainer be bonded to the substrate while preventing the substrate from drawn via adhesive to come off the loading pedestal.

### BACKGROUND OF THE INVENTION

1. Technical Field

This invention relates to a substrate bonding apparatus, more specifically to the substrate bonding apparatus for bonding a retainer smaller than the substrate to the substrate surface opposite the information recording surface.

2. Related Art

A conventional apparatus for bonding together optical disk substrates in the manufacture of optical disks is known. The apparatus, while suctioning and holding two optical disk substrates, bonds together their surfaces that are not suctioned, through adhesive (For example, refer to the Patent Document 1). The above apparatus manufactures optical disks by bonding together information recording surfaces of two equal-sized substrates. Therefore, in manufacture, the surfaces not for recording information are suctioned and held with the optical disk substrate bonding apparatus.

On the other hand, another optical disk different from the above is known, with a retainer bonded to the surface, opposite the surface for recording information, of an optical disk (For example, refer to the Patent Document 2). This optical disk has its information recording surface on the side which the retainer is not bonded to and the thickness including the optical disk substrate and the retainer is specified to fall within predetermined dimensions by relevant standard.

[Patent Document 1]

JP-A-2002-251804 (paragraph 0014, FIG. 1, etc.)

[Patent Document 2]

U.S. Patent application 2006/0048167; Specification (paragraphs 0086-0094, FIGS. 16-19C, etc.)

If it is attempted to manufacture the optical disk described in the Patent Document 2 using the bonding apparatus described in the Patent Document 1, the information recording surface of the optical disk substrate results in being suctioned and held, and might be damaged.

The object of this invention in view of the above problem is to provide a substrate bonding apparatus, for manufacturing retainer-attached disks, capable of meeting requirements specified by relevant standard while reducing the risk of damage on the information recording surface.

### SUMMARY OF THE INVENTION

To achieve the above object, a substrate bonding apparatus according to Aspect (1) of the present invention, comprises as shown in FIG. 1 and FIG. 2 e.g., a loading pedestal 11 on which a plate-shaped substrate D is placed; a suctioning and holding member 21 (see FIG. 2) for suctioning and holding a plate-shaped retainer R smaller than the substrate D on a side opposite the loading pedestal 11 beyond the substrate D placed on the loading pedestal 11; a moving device 13m for bringing the loading pedestal 11 and the suctioning and holding member 21 close toward each other so that the substrate D placed on the loading pedestal 11 and the retainer R suctioned and held with the suctioning and holding member 21 connected through adhesive; and a pressing member 25 for pressing down the substrate D placed on the loading pedestal 11 so that the substrate D does not come off the loading pedestal 11.

The above constitution, as the loading pedestal on which the substrate is placed is provided, damage on the substrate surface on the side of substrate loading pedestal is reduced in comparison with the case of suctioning and holding the substrate. Besides, as the pressing member for holding down the substrate that prevents the substrate placed on the loading pedestal from coming off the loading pedestal is provided, it is possible to bond the retainer to the substrate while preventing the substrate placed on the loading pedestal (not suctioned and held) from coming off the loading pedestal by being drawn toward the retainer through the adhesive. This makes it possible to bond the retainer to the substrate while meeting standard requirements.

The substrate bonding apparatus according to aspect (2) of the present invention is a substrate bonding apparatus of Aspect (1), as shown in FIG. 2 e.g., wherein, the pressing member 25 is attached to the suctioning and holding member 21 via an elastic member 26, the pressing member 25 contacts the substrate D before the substrate D and the retainer R are caused to contact each other through the adhesive by an action of the moving device 13m (see FIG. 1 e.g.), and the substrate D is pressed against the loading pedestal 11 (see FIG. 1 e.g.) by a restoring force of the elastic member 26 when the substrate D and the retainer R contact each other through the adhesive.

The above constitution, a simple one using elastic member, makes it possible to bond the retainer to the substrate while preventing the substrate from displacing on the loading pedestal.

The substrate bonding apparatus according to aspect (3) of the present invention is a substrate bonding apparatus 1 of Aspect (1) or Aspect (2), as shown in FIG. 1 e.g., wherein, the adhesive is composed to cure at a predetermined bonding strength when a predetermined wavelength of electromagnetic wave is irradiated, and further comprises: an irradiating device 14 for irradiating from a side of the substrate D the predetermined wavelength of electromagnetic wave to the adhesive present between the substrate D and the retainer R connected through the adhesive.

The above constitution makes it possible to fix relative positions of the substrate and the retainer in a shorter period of time in comparison with curing the adhesive by heat.

According to the invention, as the loading pedestal on which the substrate is placed is provided, damage on the substrate surface on the loading pedestal side is reduced in comparison with the case of suctioning and holding the substrate. As the pressing member for holding down the substrate placed on the loading pedestal is provided so that the substrate does not come off the loading pedestal, it is possible to bond the retainer to the substrate while preventing the substrate placed on the loading pedestal from being drawn toward the retainer through the adhesive and coming off the loading pedestal.

The basic Japanese Patent Application No. 2008-132418 filed on May 20, 2008 is hereby incorporated in its entirety by reference into the present application. The present invention will become more fully understood from the detailed description given hereinbelow. The other applicable fields will become apparent with reference to the detailed description given hereinbelow. However, the detailed description and the specific embodiment are illustrated of desired embodiments of the present invention and are described only for the purpose of explanation. Various changes and modifications will be apparent to those ordinary skilled in the art on the basis of the detailed description.

The applicant has no intention to give to public any disclosed embodiments. Among the disclosed changes and modifications, those which may not literally fall within the scope of the present claims constitute, therefore, a part of the present invention in the sense of doctrine of equivalents.

### BRIEF DESCRIPTION OF DRAWINGS

FIG. 1 is a schematic perspective view of a substrate bonding apparatus according to an embodiment of the invention.

FIG. 2 is a schematic vertical sectional view of the retainer suctioning section as a component of the substrate bonding apparatus according to an embodiment of the invention.

FIG. 3A is a schematic perspective view of the state before being bonded together, a drawing for explaining the substrate and retainer.

FIG. 3B is a schematic perspective view of the bonded state, a drawing for explaining the substrate and retainer.

FIG. 3C is a partial sectional view of the bonded state, a drawing for explaining the substrate and retainer.

FIG. 4 is a partial sectional view of the contact area between the loading pedestal and the substrate.

FIG. 5 shows states of the substrate bonding apparatus, according to an embodiment of the invention, in main steps of bonding the retainer to the substrate.

FIG. 6 is a drawing for explaining a problem that could occur when no pressing member were provided.

### DETAILED DESCRIPTION OF THE PREFERRED EMBODIMENT

An embodiment of the invention will be described hereinafter in reference to the appended drawings. Incidentally, as for all the drawings, like or corresponding components are provided with reference numerals and symbols that are the same as or similar to each other to avoid redundant descriptions.

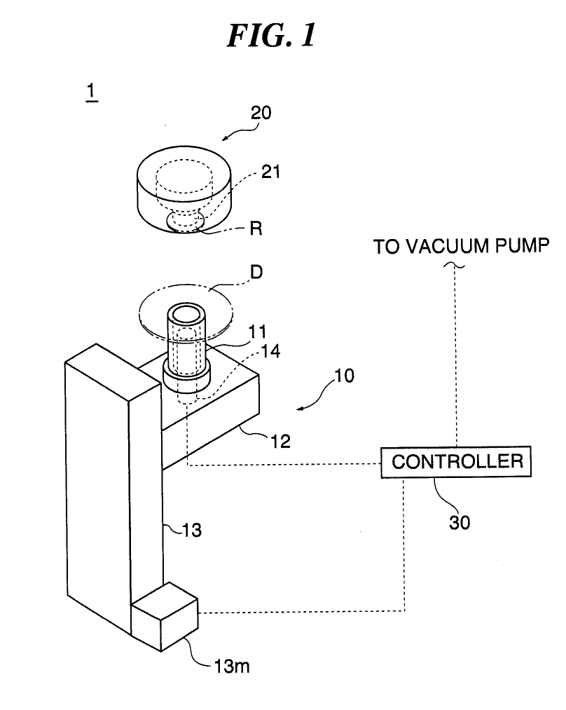

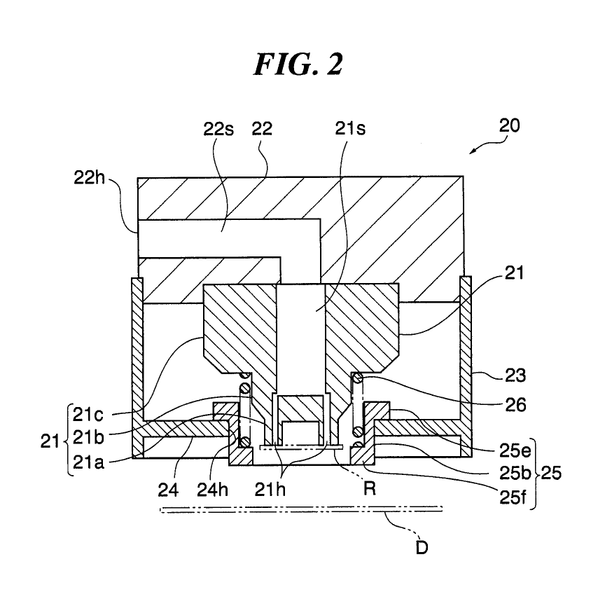

First, in reference to FIG. 1, a substrate bonding apparatus 1 according to an embodiment of the invention is described. FIG. 1 is a schematic perspective view of the substrate bonding apparatus 1. The substrate bonding apparatus 1 comprises: a substrate loading section 10 for supporting a substrate D; a retainer suctioning section 20 for holding a retainer R; and a controller 30 for controlling the action of the substrate bonding apparatus 1. The substrate loading section 10 includes: a substrate loading pedestal 11 on which the substrate D is placed; a base 12 for supporting the loading pedestal 11; a stepping motor 13m as a moving device for moving the base 12 vertically up and down; and an irradiating device 14 for irradiating a predetermined wavelength of electromagnetic waves to part of the substrate D the retainer R is bonded to. Detailed constitution of the retainer suctioning section 20 is shown in FIG. 2.

FIG. 2 is a schematic vertical sectional view of the retainer suctioning section 20. In FIG. 2, the vertical direction on the drawing corresponds to the actual vertical direction. The retainer suctioning section 20 includes: a suctioning head 21 as a member for suctioning and holding the retainer R; a head fixing section 22 for supporting the suctioning head 21; a shade 23 horizontally surrounding the suctioning head 21; a push pin 25 as a pressing member for pressing the substrate D toward the side opposite the retainer R; and a spring 26 as an elastic member for urging the push pin 25 downward. The retainer suctioning section 20 is secured to a turning arm (not shown) that turns in horizontal direction.

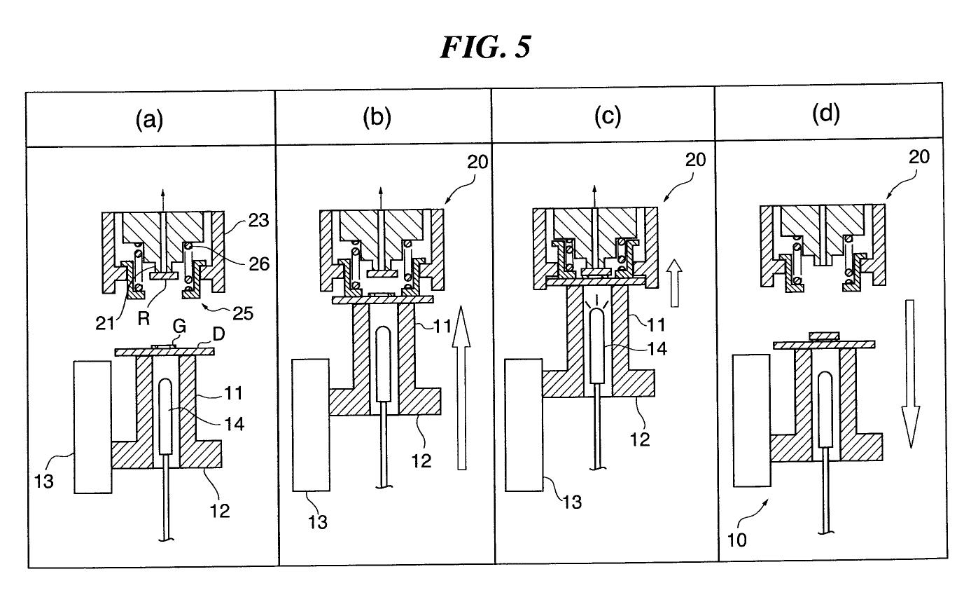

Here in reference to FIG. 1, positional relationship between the loading pedestal 11 and the suctioning head 21 will be described. A supporting column 13 and the turning arm are attached to a common trunk member (not shown). Therefore, the position of the base 12 supported with the supporting column 13 and the position of the retainer suctioning part 20 secured to the turning arm may be determined in predetermined mutual relationship. This results in that the position of the loading pedestal 11 and the position of the suctioning head 21 may be determined in predetermined mutual relationship. Therefore, the position of the substrate D and the position of the retainer R may be determined in predetermined mutual relationship. The predetermined mutual relationship mentioned here is typically the positional relationship when the retainer R is bonded to the substrate D (See FIG. 5). In order to position the loading pedestal 11 and the suctioning head 21, typically either one is accurately moved with the stepping motor. However, the way of finally determining the positional relationship is not limited to the above but may also be made accurately with a mechanical or physical stop mechanism.

Here, before explaining the retainer suctioning section 20 and the substrate loading section 10 in detail (See FIG. 1), the substrate D and the retainer R to be bonded together with the substrate bonding apparatus 1 (See FIG. 1) will be described.

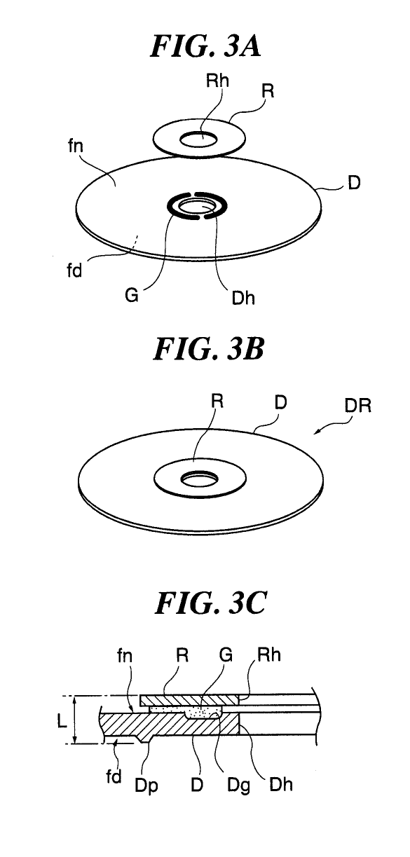

FIG. 3A, 3B, 3C are drawings for explaining the substrate D and the retainer R. FIG. 3A is a schematic perspective view of the state before being bonded together. FIG. 3B is a schematic perspective view of the bonded state, FIG. 3C is a partial sectional view of the bonded state. The substrate D is typically an optical disk substrate made by injection forming of polycarbonate in circular plate shape. In place of polycarbonate, other plastic materials maybe used such as: methyl poly-metacrylate, epoxy resin, cyclic olefin resin, poly-lactic acid, etc. The substrate D is typically about 32 mm in diameter, about 0.55 mm in thickness, with a center hole Dh of about 4.010-4.022 mm in diameter. The circumference of the substrate D and the center hole Dh are concentric. One surface of the substrate D remains intact as material to be non-information recording surface fn, the surface opposite the non-information recording surface fn is made as an information recording surface fd with a film laid by metallic vapor deposition. The metallic film on the information recording surface fd is laid outside a rim Dp formed in convex shape (projection shape) surrounding the center hole Dh. The rim Dp is formed in annular shape around the center hole Dh, nearly the same in diameter as the outside of the retainer R. Part of the information recording surface fd side surface, inside the rim Dp (on the center side), also remains as raw material and is constituted to permit ultraviolet rays to pass through. In the vicinity of the center hole Dh of the non-information recording surface fn, a groove Dg of about 1 mm in width is formed as a guide for receiving adhesive G. The groove Dg is formed annularly around the center hole Dh, smaller in diameter than the rim Dp, located typically on the center hole Dh side of the radial middle between the outermost part of the center hole Dh and the innermost part of the rim Dp.

The adhesive G is composed to cure to such an extent as to temporarily hold together the substrate D and the retainer R when an ultraviolet ray (electromagnetic wave of predetermined wavelength) is cast. Here, “temporarily hold together” means to hold the retainer R in contact with the substrate D to such an extent as the substrate D and the retainer R do not come apart (to an extent their relative positions remain unchanged) up to the time the adhesive G is finally cured by casting an ultraviolet ray or by heating. Besides, “finally cured” means to attach the retainer R to the substrate with such an extent of strength that is practicable in a disk drive such as an information reading device. In this embodiment, the predetermined wavelengths of electromagnetic rays are ultraviolet rays. In some cases, however, depending on the property of the adhesive G, the electromagnetic waves may be radio waves, infrared rays, visible light, X-rays, and gamma rays. In addition to the above classification, there may be a case in which the electromagnetic rays are specified to be within a specific range of wavelengths (in nanometer).

The retainer R is a component utilized for holding a disk DR (a final form of the substrate D with necessary components such as the retainer R, etc. provided to be usable) when information is reproduced with a disk drive such as an information reading device. The retainer R is a magnetic body of metal, etc. of circular plate shape. The retainer R is typically about 9.2 mm in diameter, about 0.2 mm in thickness, and with a center hole Rh of about 4.5 mm in diameter formed in the center. The circumference of the retainer R and the center hole Rh are concentric. The disk DR with the retainer R bonded is constituted in a manner such that the retainer R is attracted and held with a magnetic member (such as an electromagnet) provided in the disk drive. The retainer R and the substrate D, when made into the disk DR, are bonded together so that their circumferences are concentric.

The disk DR is required by a relevant standard that the distance L (thickness) between the tip of the rim DP formed on the information recording surface fd of the substrate D and the surface opposite the bonded surface of the retainer R fall within a predetermined range. As to the substrate D and retainer R produced in large quantities, individual difference such as dimensional error in manufacture occurs inevitably. Therefore, simply pressing the retainer R against the substrate D, when bonding them together, does not always bring the thickness (distance L) of the finished disk DR within the predetermined range required by the standard. The disk DR is required to absorb individual difference occurring on the substrate D and retainer R by adjusting the thickness of the adhesive G used when bonding together the substrate D and retainer R. The standard also requires that the adhesive G not protrude beyond the retainer R. Incidentally, while the above explanation refers to specific dimensions and materials of the substrate D and retainer R, they may be appropriately changed within conforming to the standard.

Referring back to FIG. 1, explanation on the constitution of the substrate bonding apparatus 1 will be continued. The loading pedestal 11 is formed in hollow cylindrical shape. In this embodiment, the loading pedestal 11 is formed about the same in diameter as the rim Dp (See FIG. 3C) formed on the substrate D. The loading pedestal 11 is attached to the base 12 with its cylinder axis in the vertical direction.

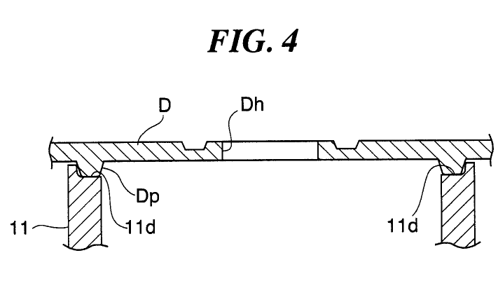

As seen in FIG. 4, a partially sectioned view showing the contact area between the loading pedestal 11 and the substrate D, the top end of the loading pedestal 11 in the cylindrical shape is formed with a recess 11d formed to descend by one step on the inside diameter side, so that the rim Dp of the substrate D may fit in the recess 11d. Such a constitution makes it possible that the substrate D, even when simply placed on the loading pedestal 11, is restrained from moving horizontally. Besides, the recess 11d is made smaller in depth than the projection of the substrate D, so that the recess 11d contacts the tip of the rim Dp when the substrate D is placed on the loading pedestal 11, and part of the loading pedestal 11 higher by one step than the recess 11d does not contact the substrate D. The above constitution is preferable because no external force is applied to the information recording surface fd (See FIGS. 3A and 3C) of the substrate D and so the substrate is prevented from being damaged and because part of the substrate D near the part where the retainer R is bonded to (See FIG. 3C) is supported with the loading pedestal 11. Incidentally, the recess 11d may be formed to descend by one step on the outside diameter side.

Referring back to FIG. 1, explanation will be continued. An irradiating device 14 for irradiating ultraviolet rays (electromagnetic waves of predetermined wavelengths) is provided in the hollow part of the loading pedestal 11 in the cylindrical shape. The irradiating device 14 is electrically connected to a controller 30 and constituted to be capable of controlling the timing of irradiating ultraviolet rays. Also the irradiating device 14 is attached to the base 12. The base 12 is attached to a supporting column 13 so as to be vertically movable.

The supporting column 13 has a guiding groove (not shown) for vertically guiding the base 12, and also has a stepping motor 13m for vertically moving the base 12 along the guiding groove. As the base 12 is capable of moving vertically, the loading pedestal 11 connected to the base 12 is also constituted to be capable of moving vertically. The stepping motor 13m is electrically connected to the controller 30 and constituted to be capable of controlling the vertical travel of the base 12.

Moving on to FIG. 2, constitution of the retainer suctioning section 20 will be described in detail. The suctioning head 21 is made as a cylindrical member of external shape consisting of three parts of different outside diameters located in axial succession. That is to say, the suctioning head 21 as a single member is made up of: a small head part 21a, the smallest in outside diameter; a middle head part 21b, larger in outside diameter than the small head part 21a; and a big head part 21c, larger in outside diameter than the middle head part 21b. The three parts are coaxially located in this order. The end face on the small head 21a side of the suctioning head 21 is provided with a plurality of suctioning holes 21h, for auctioning and holding the retainer R, along a circle concentric with the cylinder axis. The circle assumed to appear when the plurality of suctioning holes 21h are located in succession along the circumferential direction of the suctioning head 21 is larger in radius than the circumference of the center hole Rh of the retainer R (See FIGS. 3A, 3B & 3C); typically the radius is half the sum of the circumference radius of the center hole Rh of the retainer R and the outside circumference radius of the retainer R itself. The small head part 21a of the suctioning head 21 is formed to be smaller in outside diameter than the retainer R, and the middle head part 21b is formed to be larger in outside diameter than the retainer R. The plurality of suction holes 21h communicate respectively with a suction passage 21s or a cavity formed in the suctioning head 21 on the same axis as that of the cylinder. The suction passage 21s reaches the end face on the big head 21c side of the suctioning head 21. The suctioning head 21 is attached to the head fixing section 22 so that the cylinder axis is in vertical direction and the end face of the small head part 21a faces downward. With the above constitution, a single assembly is constituted with a suction-holding member and a pressing member without interfering with the retainer. Incidentally, on the middle head part 21b side of the big head part 21 is formed with, as shown in the drawing, an end face at right angles to the circumferential surface of the middle head part 21b or to the cylinder axis.

The end face of the suctioning head 21 on the small head part 21a side is formed with a projection (not shown) for fitting into the center hole Rh of the retainer R. The projection is formed smaller in diameter than the center hole Rh to an extent that permits the above fitting. While the projection is typically in annular shape, it may also be in solid disk shape. The height of the projection from the end face on the small head part 21a side is preferably nearly the same as the thickness of the retainer R. However, as long as the projection engages sufficiently with the retainer R, the above height may be less than the thickness of the retainer R. In this way, interference between the projection and the substrate D may be avoided when the substrate D and the retainer R are bonded together. The tip of the projection is preferably tapered or chamfered so that the projection may be inserted smoothly into the center hole Rh of the retainer R. In this case, the height to the root of the taper or the chamfer is preferably smaller than the thickness of the retainer R. Providing such a projection makes it possible to facilitate axial alignment of the retainer R and the substrate D.

The head fixing section 22 is made as a cylindrical column member larger in diameter than both the big head part 21c and the substrate D. The head fixing section 22 has a cavity as a suction passage 22s extending along the axis from the central part of the face on the side connected to the suctioning head 21. The suction passage 22s changes its direction near the center of the cylindrical column axis perpendicular to the cylindrical column axis, extends and opens (22h) to the side face. The side opening 22h formed on the side face of the head fixing section 22 is connected through a suction pipe (not shown) to a vacuum pump (not shown). The head fixing section 22 and the suctioning head 21 are connected together so that the suction passage 22s of the head fixing section 22 and the suction passage 21s of the suctioning head 21 are in fluid communication without causing leakage. The face of the head fixing section 22 on the side connected to the suctioning head 21 faces vertically downward. The lower circumferential part of the head fixing section 22 is provided with the shade 23.

The shade 23 is a member for preventing diffusion of ultraviolet rays when they are irradiated from the irradiating device 14 (See FIG. 1). The shade 23 is made in cylindrical shape of nearly the same outside diameter as that of the head fixing section 22 and of inside diameter somewhat larger than the outside diameter of the substrate D. The shade 23 extends vertically downward from the lower circumferential part of the head fixing section 22 while surrounding the suctioning head 21. The shade 23 is made larger in axial length than the suctioning head 21. As the material of the shade 23, aluminum, or synthetic resin or glass having the property of absorbing ultraviolet rays is used.

A stop member 24 for receiving the push pin 25 is provided inside the shade 23. The stop member 24 is a member of circular plate shape, in the center of which is formed a center through hole 24h larger in diameter than the middle head part 21b of the suctioning head 21. The stop member 24 is attached to the inside of the shade 23, in the axial middle of the small head part 21a of the suctioning head 21, with its face directed downward (with its face extending perpendicular to the vertical axis). Incidentally, the stop member 24 may be made integral with the shade 23.

The push pin 25 is made up of a cylinder portion 25b, of an outside diameter to fit into the through hole 24h of the stop member 24, with its one end having an outer flange 25e extending outward while its other end having an inner flange 25f extending inward. The inside diameter of the cylinder portion 25b is made larger than the sum of the outside diameter of the middle head part 21b of the suctioning head 21 and twice the thickness of the spring 26. The outside diameter of the outer flange 25e is made larger than the outside diameter of the through hole 24h of the stop member 24 and smaller than the inside diameter of the shade 23. The inside diameter of the inner flange 25f is made larger than the outside diameter of the retainer R and equal to or smaller than the outside diameter of the middle head part 21b of the suctioning head 21. Besides, the inside diameter of the inner flange 25f is larger than the outside diameter of the small head part of the suctioning head 21. The push pin 25, with its outer flange 25e on the upper side and the inner flange 25f on the lower side, is inserted from above the stop member 24 into the through hole 24h and held there. When the push pin 25 is placed in position, the outer flange 25e rests on the stop member 24. The length of the push pin 25 is made in the manner such that its lower end (on the inner flange 25f side), in the state of the push pin 25 resting on the stop member 24, projects down beyond the retainer R suctioned to the suctioning head 21, and to be shorter than the axial length from the border between the middle head part 21b and the big head part 21c to the end on the small head part 21a side of the suctioning head 21.

The spring 26 is typically a coil spring sized in the manner such that its inside diameter fits around the middle head part 21b of the suctioning head 21 and its outside diameter fits into the cylinder portion 25b of the push pin 25. The spring 26 is fitted over the middle head part 21b of the suctioning head 21 attached to the head fixing section 22. The push pin 25 is fitted from under over the spring 26. The push pin 25 is fitted into the through hole 24h of the stop member 24. The shade 23 is secured to the head fixing section 22. Thus, the spring 26 is installed in the retainer suctioning section 20. Thus, the spring 26 is in a position between the end face of the big head part 21c on the middle head part 21b side and the inner flange 25f. The spring 26 has such an extent of elasticity that urges the outer flange 25e to come into contact with the stop member 24 when the tip of the push pin 25 is not in contact with the substrate D, and that the substrate D sustains no damage when the tip of the push pin 25 and the retainer R come into contact with the substrate D.

Referring back to FIG. 1, explanation will be continued. The controller 30 controls the substrate bonding apparatus 1. The controller 30 is connected through a signal cable to the stepping motor 13m and constituted to be capable of moving the base 12 vertically up and down over an arbitrary travel within the range of the length of a guide groove (not shown) formed in the supporting column 13. The controller 30 is also connected through a signal cable to the irradiating device 14 and is constituted to be capable of controlling whether or not ultraviolet rays should be irradiated. The controller 30 is also connected through a signal cable to a vacuum pump (not shown) and is constituted to be capable of controlling whether or not suction through the suction holes 21h of the suctioning head 21 should be carried out.

Next, in reference to FIG. 5, the function of the substrate bonding apparatus 1 will be described. FIG. 5 shows states of the substrate bonding apparatus 1 in major steps of bonding the retainer R to the substrate D. Incidentally, in the following explanation, FIGS. 1 to 4 are appropriately referred to for reference numerals and symbols of components of the substrate bonding apparatus 1, substrate D, and retainer R.

The substrate D is transferred, with adhesive G applied to the groove Dg in the step before being placed on the loading pedestal 11, with its periphery gripped by a transfer arm (not shown). The adhesive G is applied in the shape of a circle, semicircle, or a plurality of dots and in such an amount that makes it possible to bond the retainer R to the substrate D with a strength that can stand the use in the disk drive such as an information reading device and that the bond or adhesive does not protrude over the periphery of the retainer R during the bonding step. The substrate D, that has been transferred by the transfer arm (not shown), is placed on the loading pedestal 11 with its information recording surface fd facing downward so that the rim Dp fits into the recess 11d of the loading pedestal 11 (See FIG. 4). The substrate D is merely resting on the loading pedestal 11 and is not suctioned and held. Therefore, the information recording surface fd of the substrate D is prevented from being damaged. At this time, the base 12 is in the state of having come down. On the other hand, the turning arm (not shown), to which the suctioning section 20 is attached, turns toward a retainer stocker (not shown) to contact one of the retainers R stored in the retainer stocker (not shown). As the vacuum pump (not shown) is operated, the suctioning head 21 suctions and holds the retainer R. The retainer suctioning section 20, suctioning and holding the retainer R, is moved as the turning arm (not shown) turns to a position vertically above the substrate D. At this time, the retainer suctioning section 20 is not in contact with both the substrate D and substrate loading section 10, and the inner flange 25f of the push pin 25 of the retainer suctioning section 20 projects down beyond the retainer R held with the suctioning head 21 (See FIG. 5(a)).

When the retainer suctioning section 20 holding the retainer R comes above the loading pedestal 11 on which the substrate R is placed, the controller 30 operates the stepping motor 13m to move the base 12 upward. In the controller 30, the distance between the loading pedestal 11 and suctioning head 21 are stored or memorized in advance, and the base 12 is lifted at a high speed up to a position just before the substrate D contacts the push pin 25. The controller 30 controls the stepping motor 13m to decelerate the lifting speed of the base 12 when the substrate D comes to a position before contacting the push pin 25. The base 12 continues rising until the inner flange 25f of the push pin 25 comes into contact with the non-information recording surface fn of the substrate D. As the push pin 25 is urged downward with the spring 26, the substrate D in contact with the push pin 25 is pressed against the loading pedestal 11. Thus, the substrate D, not suctioned and held, is prevented from being set afloat or horizontally moved from the loading pedestal (See FIG. 5(b)).

Also after the substrate D contacts the push pin 25, the base 12 continues rising at a low speed. When the vertical distance between the bottom of the recess 11d of the loading pedestal 11 and the end face on the small head part 21a side of the suctioning head 21 becomes L (See FIG. 3C), the controller 30 stops the stepping motor 13m to stop lifting the base 12. At this time, the retainer R is connected through the adhesive G to the substrate D. In other words, the retainer R and the substrate D are bonded together with the adhesive G. The adhesive G does not extrude from the retainer R to conform to the requirement of the standard. At this time, due to surface tension of the adhesive G, a force may work to attract the substrate D, placed without being suctioned and held on the loading pedestal 11, toward the retainer R. However, as the substrate D is pressed with the push pin 25 against the loading pedestal 11, it does not occur that the distance L cannot be maintained as the substrate D is attracted with such a force. That is, as the substrate D is pressed with the push pin 25 against the loading pedestal 11, it is possible to make the distance between the tip of the rim Dp and the top surface (the surface opposite the substrate D side) of the retainer R to be L within the range required by the standard. Besides, as the loading pedestal 11 supports the substrate D at the rim Dp near the position of the retainer R in the horizontal direction, it is possible to prevent deflection of the substrate D from occurring for example when the central area of the substrate D is pressed while the circumference of the substrate D is supported. Next, the controller 30 sends a signal to the irradiating device 14 to irradiate ultraviolet rays to the adhesive G. As the substrate D is supported at the rim Dp rather than the center hole Dh or its vicinity, ultraviolet rays may be irradiated to the adhesive G applied around the center hole Dh without being obstructed with the loading pedestal 11. When ultraviolet rays are irradiated to the adhesive G, the adhesive G is cured with the ultraviolet rays, and relative positions of the substrate D and retainer R are fixed. The adhesive G is cured with the ultraviolet rays at a temporary securing strength. Curing the adhesive G at the temporary securing strength using ultraviolet rays makes it possible to release the positions of loading table 11 and suction head 21 within a shorter period of time than when curing by heating. This makes it possible to shorten cycle time and improve productivity (See FIG. 5(c)).

When the adhesive G cures at the temporary securing strength, the controller 30 stops the vacuum pump (not shown) to release the retainer R suctioned and held with the suctioning head 21, and operates the stepping motor 13m to lower the base 12. Whether or not the adhesive G has cured at the temporary securing strength may be determined by measuring in advance the time required for the adhesive G to cure at the temporary securing strength, storing the time in the controller 30, and detecting the passage of the time. When the base 12 descends to a predetermined position, the controller 30 stops the stepping motor 13m and stops the descent of the base 12. When the base 12 stops descending, the substrate D placed on the loading table 11, with the retainer R attached, is transferred with the transfer arm (not shown) to a next step (See FIG. 5(d)).

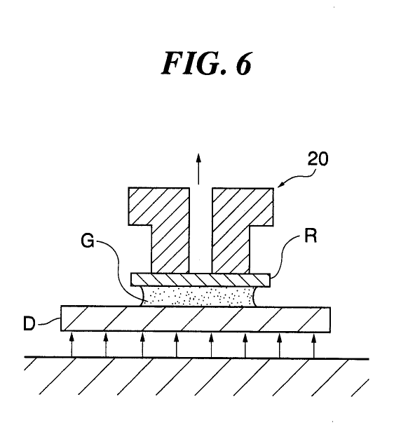

As described above, with the substrate bonding apparatus 1 according to an embodiment of the invention, because the loading pedestal 11 merely supports the weight of the substrate D without suctioning and holding the information recording surface fd of the substrate D, the information recording surface fd is prevented from being damaged. Besides, as the retainer R is bonded to the substrate D while the substrate D is pressed with the push pin 25 against the loading pedestal 11, the thickness of the substrate D with the retainer R attached may be made to meet the requirement of the standard. Thus, it is possible to prevent a problem, which occurs when no pressing member such as the push pin 25 is provided, that the substrate D is drawn via the adhesive G toward the retainer R and away from the loading pedestal 11 (See FIG. 6), and it is possible to put the retainer R to the substrate D with the adhesive to meet the requirement of the standard. Besides, as the adhesive G is cured with ultraviolet rays at the temporary securing strength, cycle time is shortened to improve productivity. Moreover, as the loading pedestal 11 supports the substrate D at the rim Dp near the position of the retainer R in the horizontal direction, it is possible to curb the warping of the substrate D even if the substrate D is pressed with the push pin 25 against the loading table 11.

In the above explanation, the small head part 21a is assumed to be made smaller in diameter than the retainer R. However, the small head part 21a maybe made larger than or the same as the retainer R in diameter.

In the above explanation, the suction-holding member is assumed to be the suctioning head 21 that suctions and holds the retainer R by suctioning with the vacuum pump. However, the suction-holding member may also be constituted to attract and hold the substrate D with a magnet. In the case the suction-holding member is made as an electromagnet, it is possible to attract and hold the retainer R by applying electric current to the electromagnet, and stop the electric current when the retainer R is temporarily secured to the substrate D as described above. In the case the suction-holding member is made as a permanent magnet, it may be constituted to have a magnetic force of an extent that the retainer R temporarily secured to the substrate D is removed by a pulling force while a retainer R not connected to the substrate D is attracted and held.

The substrate D, with the retainer R temporarily secured, is removed from the loading pedestal 11, and is subjected to additional irradiation of ultraviolet rays or heating to be finally secured. Or, an alternative constitution is possible in which sufficient amount of ultraviolet rays is irradiated for the final securing while the substrate remains placed on the loading pedestal 11.

In the above explanation, while the elastic member is assumed to be the spring 26, it may be a member other than spring such as rubber. The elastic member (spring 26) may be formed integrally with the pressing member (push pin 25), or part or whole of the pressing member (push pin 25) may be formed with an elastic body. When the spring is specifically a compression spring, the spring constant may be chosen freely. In particular, because the spring constant may be set relatively small, the vertical travel of the push pin 25 may be set large without excessively increasing the force working on the retainer. When rubber is used, the constitution may be simplified to make the apparatus compact.

In the above explanation, while it is assumed that the adhesive G is applied to the substrate D before the substrate D and the retainer R are put together, the adhesive G may be applied to the retainer R. While it is also assumed that the base 12 (substrate D side) is moved when the substrate D and the retainer R are put together, it may be assumed that the retainer suctioning section 20 (retainer R side) is moved, or both the substrate D side and retainer R side are moved. Because the adhesive application surface of the substrate D faces upward in the vertical direction in all or almost all the period of the bonding process, the application is easy and the adhesive is likely to remain in the applied position, when the adhesive G is applied to the substrate D.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing,” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### DESCRIPTION OF REFERENCE NUMERALS AND SYMBOLS

1: substrate bonding apparatus
11: loading pedestal
13m: stepping motor
14: irradiating device
21: suctioning head
22: head fixing section
23: shade
24: stop member
25: push pin
26: spring
D: substrate
R: retainer

What is claimed is:

1. A substrate bonding apparatus comprising:
a loading pedestal on which a plate-shaped substrate is placed;
a suctioning and holding member for suctioning and holding a plate-shaped retainer smaller than the substrate on a side opposite the loading pedestal beyond the substrate placed on the loading pedestal;
a moving device for bringing the loading pedestal and the suctioning and holding member close toward each other so that the substrate placed on the loading pedestal and the retainer suctioned and held with the suctioning and holding member connected through adhesive; and
a pressing member for pressing down the substrate placed on the loading pedestal so that the substrate does not come off the loading pedestal.

2. The substrate bonding apparatus according to claim 1, wherein,
the pressing member is attached to the suctioning and holding member via an elastic member, the pressing member contacts the substrate before the substrate and the retainer are caused to contact each other through the adhesive by an action of the moving device, and the substrate is pressed against the loading pedestal by a restoring force of the elastic member when the substrate and the retainer contact each other through the adhesive.

3. The substrate bonding apparatus according to claim 1, wherein,
the adhesive is composed to cure at a predetermined bonding strength when a predetermined wavelength of electromagnetic wave is irradiated, and further comprising:
an irradiating device for irradiating from a side of the substrate the predetermined wavelength of electromagnetic wave to the adhesive present between the substrate and the retainer connected through the adhesive.

4. The substrate bonding apparatus according to claim 2, wherein,
the adhesive is composed to cure at a predetermined bonding strength when a predetermined wavelength of electromagnetic wave is irradiated, and further comprising:
an irradiating device for irradiating from a side of the substrate the predetermined wavelength of electromagnetic wave to the adhesive present between the substrate and the retainer connected through the adhesive.

5. The substrate bonding apparatus according to claim 1, wherein,
the substrate has an annular projection around a center hole,
the loading pedestal is cylindrically shaped, a top end of the loading pedestal has a recess formed on its inside circumferential side for the projection of the substrate to fit in, and a depth of the recess is smaller than the height of the projection of the substrate.

6. The substrate bonding apparatus of claim 2, wherein,
the suctioning and holding member has: a small head part having an end face for suctioning and holding the retainer, a middle head part larger in diameter than the small head part, and a big head part larger in diameter than the middle head part,
the big head part has a big head part end face formed on its middle head part side perpendicular to a circumference of the middle head part,
the pressing member has: a hollow cylindrical part with an inside diameter larger than a diameter of the middle head part; and an inner annular flange, formed on one end of the hollow cylindrical part, with an inside diameter larger than outside diameters of the small head part and the retainer, having an end face for contacting the substrate,
the elastic member is a coil spring with an inside diameter larger than the outside diameter of the middle head part and with an outside diameter smaller than an inside diameter of the hollow cylindrical part, the coil spring is fit in a position between an outside round surface of the middle head part and an inside round surface of the hollow cylindrical part and between the big head part end face and the inner flange.
